(19) United States
(12) Patent Application Publication
(10) Pub. No.: US 2019/0041179 A1
(43) Pub. Date: Feb. 7, 2019

(54) FIREARM MAGAZINE DISPENSER APPARATUS

(71) Applicant: Travis Arneson, Virginia Beach, VA (US)

(72) Inventor: Travis Arneson, Virginia Beach, VA (US)

(21) Appl. No.: 15/667,945

(22) Filed: Aug. 3, 2017

(51) Int. Cl. F42B 39/00; F42B 39/26; G07F 11/14

(52) U.S. Cl. CPC F42B 39/002; F41A 9/64; G07F 11/14; F42B 39/26

(57) ABSTRACT

A combined magazine storage, transport, and dispenser apparatus including a storage member having a storage cavity disposed between a first end and an opposing second end, the storage cavity configured to store a plurality of firearm magazines, a follower member having a first side and an opposing second side movably disposed within the storage cavity between the first and second ends of the storage member, and a spring member disposed within the storage cavity between the second side of the follower and the second end of the storage member, wherein the spring member pushes the follower member toward the first end of the storage member to provide access to the plurality of firearm magazines stored therein.

### FIELD OF INVENTION

The present general inventive concept relates to firearm magazine storage containers, and more particularly, to a combined firearm magazine storage, transport, and dispenser apparatus.

### BACKGROUND

There currently exists many types of ammunition containers, such as ammo cans, that are designed to store and transport firearm ammunition. For instance, ammo cans are specifically designed and built for bulk ammunition storage, and although they may be used to store loaded magazines, they are primarily used to store and transport loose cartridges.

Conventional ammunition containers are typically secured in place during transport by using a removable lid, a latching mechanism, and tie downs. As a result, users are required to spend a significant amount of time in order to secure as well as to obtain access to the ammunition. Thus, when the user needs the ammunition, the user must first untie the tie downs, then unlatch the latching mechanism, then remove the lid, and finally load the loose ammunition into empty magazines in order to be able to use the ammunition. As such, conventional bulk ammunition containers do not provide immediate access to the ammunition in a ready-to-use state when needed in critical situations.

Therefore, what is needed is a bulk ammunition storage container that is designed for loaded firearm magazines which provides users with immediate ready access to loaded magazines, at all times.

### SUMMARY OF THE INVENTION

The firearm magazine dispenser apparatus according to the present general inventive concept provides a combined firearm magazine storage, transport, and dispenser apparatus.

The firearm magazine dispenser apparatus according to the present general inventive concept also provides a bulk firearm magazine storage, transport, and dispenser apparatus that provides users with access to loaded firearm magazines, without the need to manipulate any latches, lids, tie downs, or any other means for securing the ammunition storage apparatus.

The firearm magazine dispenser apparatus according to the present general inventive concept also provides a bulk firearm magazine storage, transport, and dispenser apparatus that provides users with access to loaded firearm magazines from one or more opposing sides of the ammunition storage apparatus.

Features and/or utilities of the present general inventive concept may be achieved by providing a combined magazine storage, transport, and dispenser apparatus including a storage member having a storage cavity disposed between a first end and an opposing second end, the storage cavity configured to store a plurality of firearm magazines, a follower member having a first side and an opposing second side movably disposed within the storage cavity between the first and second ends of the storage member, and a spring member disposed within the storage cavity between the second side of the follower and the second end of the storage member, wherein the spring member pushes the follower member toward the first end of the storage member to provide access to the plurality of firearm magazines stored therein.

The storage member may further include a retention member integrally formed with the first end of the storage member to releasibly secure each firearm magazine stored therein.

The storage member may further include sidewalls formed in a shape corresponding to a shape of a firearm magazine.

At least one sidewall may be formed at an angle of between about 5 degrees to about 30 degrees with respect to an adjacent sidewall or horizontal axis.

At least one sidewall may be formed with one or more rounded protrusions extending into the storage cavity to reduce friction with at least one or both of the follower member and the firearm magazine.

The storage member may include one or more openings at opposing ends to insert and remove the plurality of firearm magazines from the storage cavity.

A combined width of the one or more openings (e.g., W3+W4) may be greater than half of a width (W1) of the storage member. For instance, a storage member having a width W1 of twelve inches would have a combined width of openings 110c at the first and second ends 110d and 110e of greater than six inches. As such, the combined widths of the openings W3 and W4 is greater than six inches. However, the present general inventive concept is not limited thereto.

Additional aspects of the present general inventive concept will be set forth in part in the description which follows and, in part, will be obvious from the description, or may be learned by practice of the general inventive concept.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view of a conventional firearm magazine;

FIG. 2 is a shaded front perspective view of a firearm magazine dispenser apparatus according to an exemplary embodiment of the present general inventive concept;

FIG. 3 is a front perspective view of the firearm magazine dispenser apparatus illustrated in FIG. 2;

FIG. 4 is a front perspective exploded assembly view of the firearm magazine dispenser apparatus illustrated in FIG. 3;

FIG. 5 is a bottom perspective exploded assembly view of the firearm magazine dispenser apparatus illustrated in FIG. 3;

FIG. 6 is a front view of the storage member illustrated in FIG. 3;

FIG. 7 is a side view of the storage member illustrated in FIG. 3;

FIG. 8 is a top view of the firearm magazine dispenser apparatus illustrated in FIG. 3, wherein the follower member is removed;

FIG. 9 is a bottom view of the storage member illustrated in FIG. 3;

FIGS. 10A and 10B are front partial assembly views of the firearm magazine dispenser apparatus illustrated in FIG. 3, wherein the storage member is removed;

FIGS. 11A and 11B are side partial assembly views of the firearm magazine dispenser apparatus illustrated in FIG. 3, wherein the storage member is removed;

FIG. 12 is a top view of the follower member illustrated in FIG. 3;

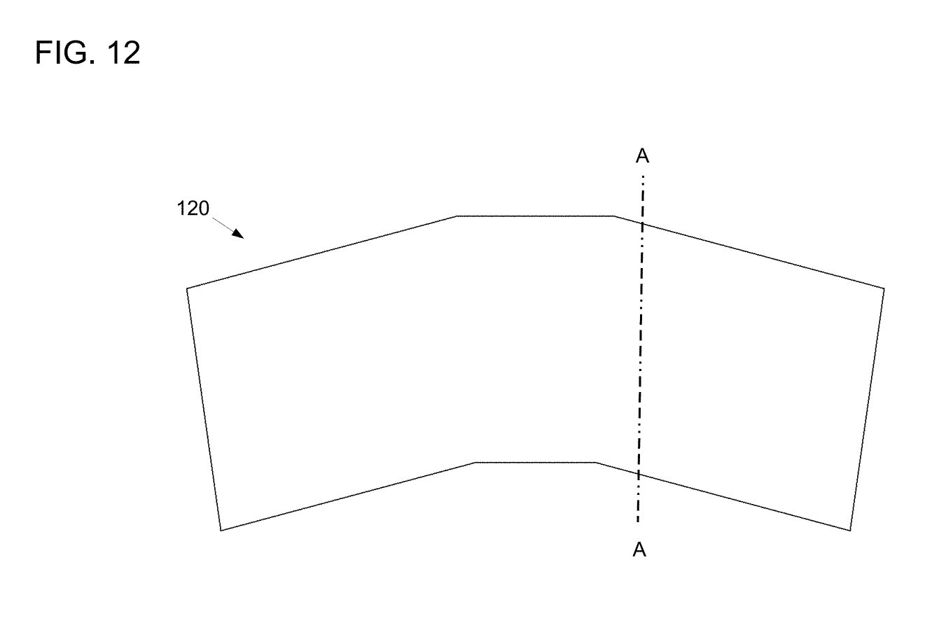

FIG. 13 is a bottom view of the follower member illustrated in FIG. 3;

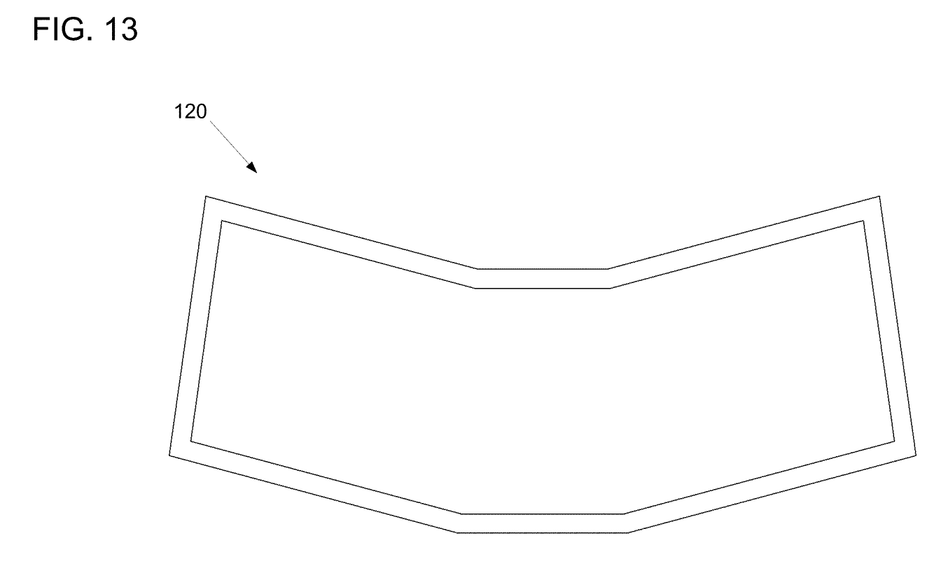

FIG. 14 is a cross-sectional view of the follower member illustrated in FIG. 12, along line A-A of FIG. 12;

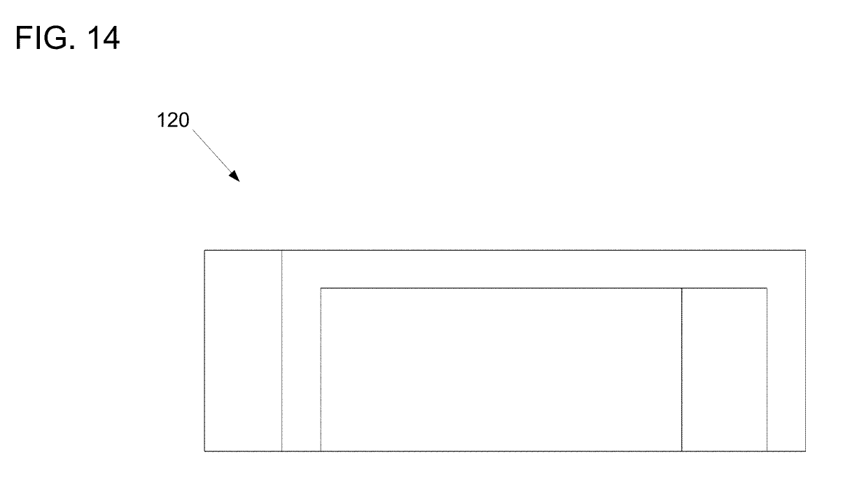

FIG. 15 is a top perspective view of a storage member according to another exemplary embodiment of the present general inventive concept; and

FIG. 16 is a cross-sectional view of the storage member illustrated in FIG. 15.

### DETAILED DESCRIPTION OF THE INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The present general inventive concept provides a firearm magazine dispenser apparatus that is designed and configured to safely store, transport, and dispense firearm magazines. The firearm magazine dispenser apparatus may be easily assembled and disassembled for maintenance, without the need of any tools. The firearm magazine dispenser apparatus may include a storage container (i.e., storage member or case) that is designed to receive one or more conventional firearm magazines. The storage container may be formed in various sizes and shapes to correspond to various firearm magazine profiles. In addition, an inner surface of the storage container may be formed with at least one rounded protrusion or bead rolled, which reduces friction with the magazine and allows the magazine to move more easily. However, the present general inventive concept is not limited thereto. That is, in alternative embodiments, the storage member may be formed with at least one protrusion having various sizes and shapes which are designed to reduce friction when in contact with a firearm magazine and/or a follower member.

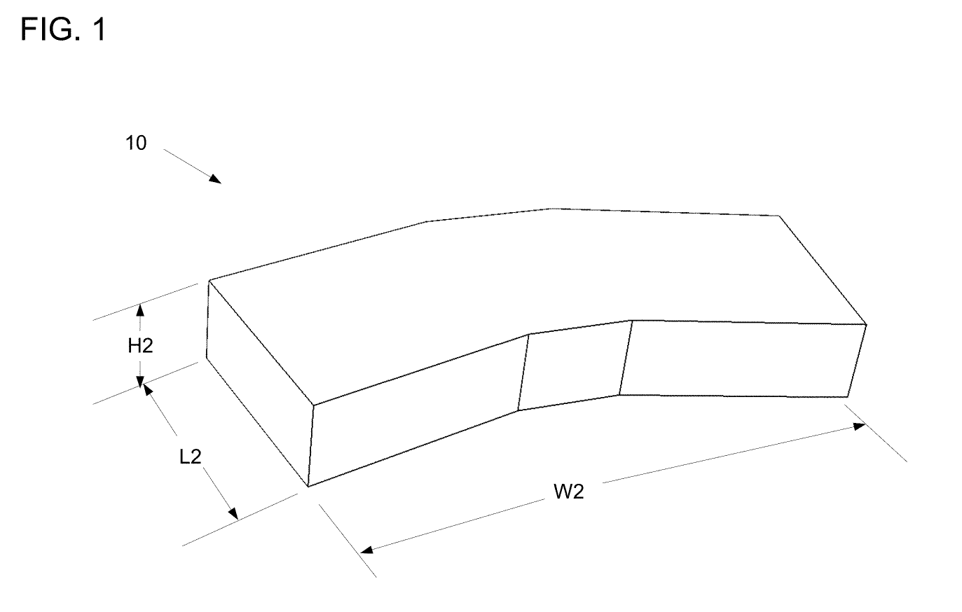

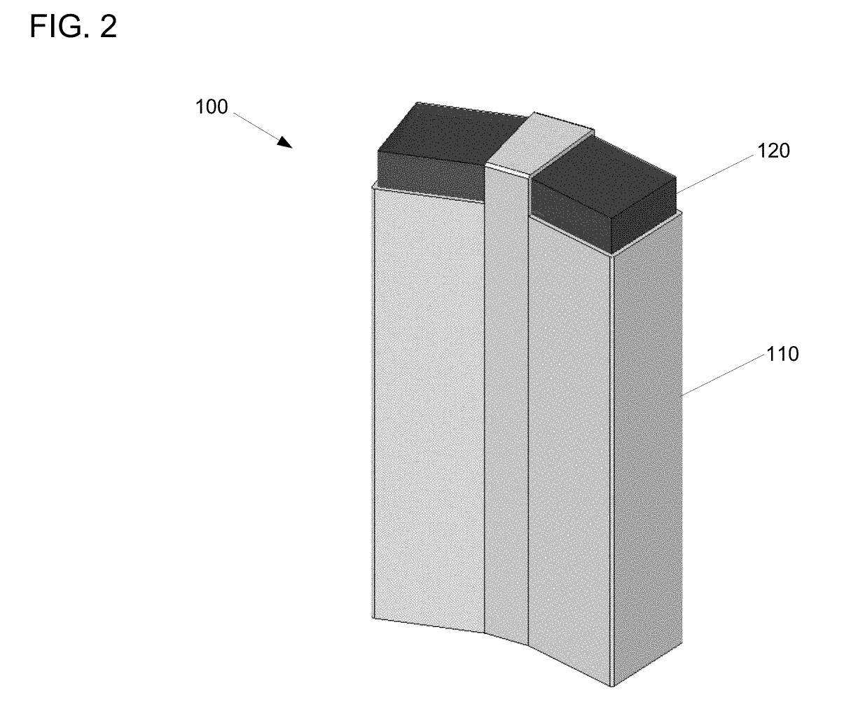

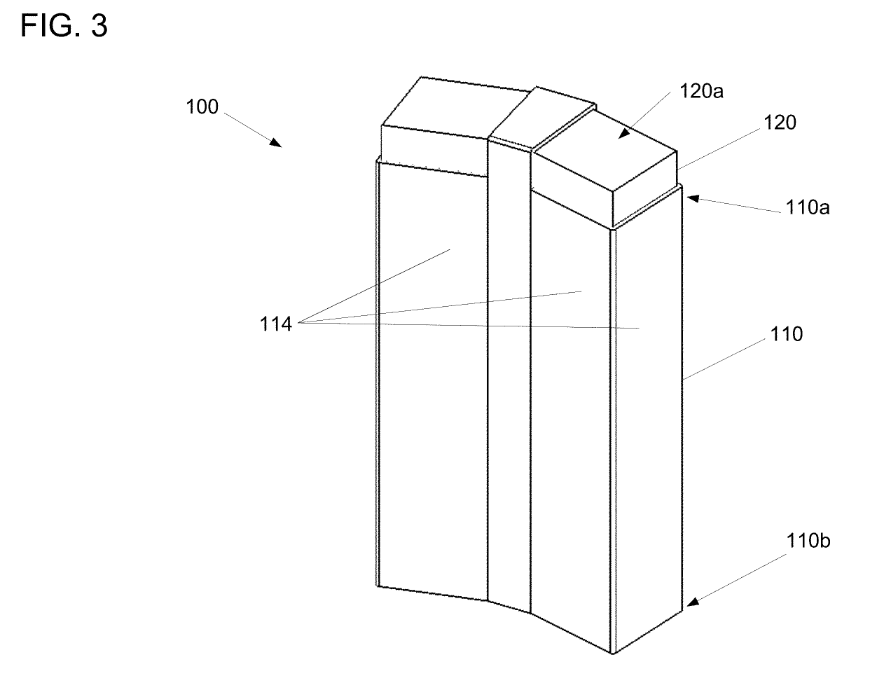

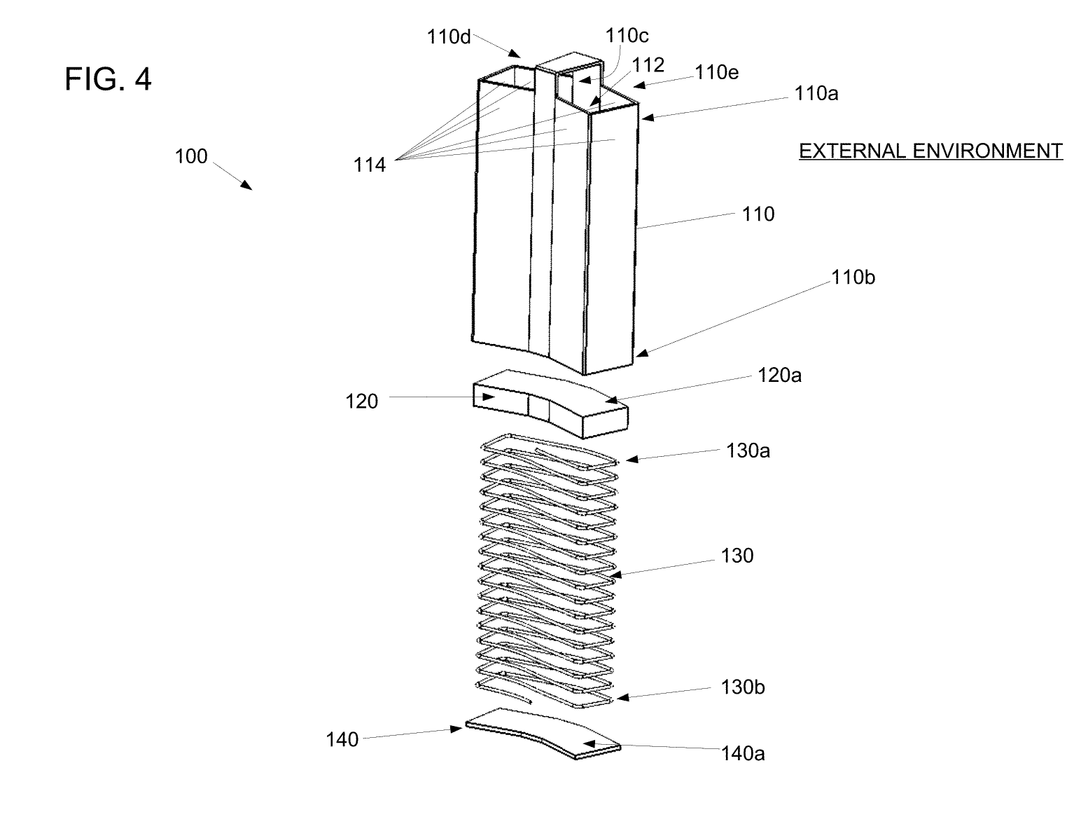

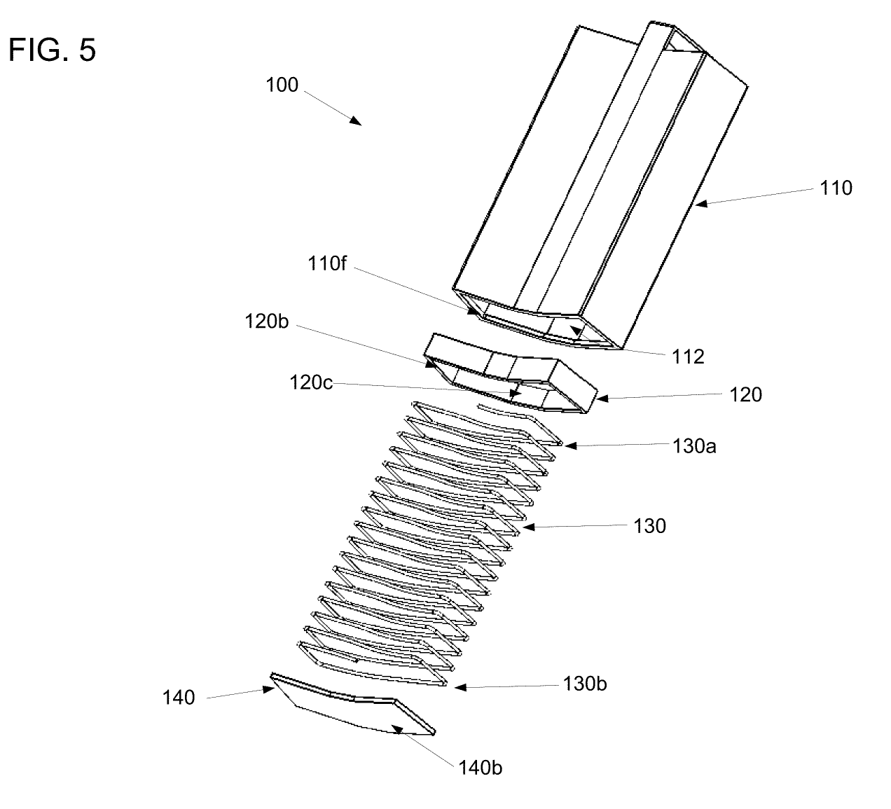

FIG. 1 is a front perspective view of a conventional firearm magazine. FIG. 2 is a shaded front perspective view of a firearm magazine dispenser apparatus 100 according to an exemplary embodiment of the present general inventive concept. FIG. 3 is a front perspective view of the firearm magazine dispenser apparatus 100 illustrated in FIG. 2, FIG. 4 is a front perspective exploded assembly view of the firearm magazine dispenser apparatus 100 illustrated in FIG. 3, and FIG. 5 is a bottom perspective exploded assembly view of the firearm magazine dispenser apparatus 100 illustrated in FIG. 3.

Referring to FIGS. 1 through 5, in an exemplary embodiment, the firearm magazine dispenser apparatus 100 includes a storage member or case 110 which may be used to store a plurality of firearm magazines 10, a follower member 120 which is disposed within the storage member 110 and is used to push against a surface of a firearm magazine, and a spring member 130 which is disposed within the storage member 110 and used to apply a force onto the follower member 120 to bias and/or push against a firearm magazine stored within the storage member 110.

Referring to FIG. 4, in the present embodiment, the storage member 110 includes a storage cavity 112 that is formed within a plurality of sidewalls 114 of the storage member 110. The plurality of sidewalls 114 may be formed from a single or multiple sheets of material or casted or molded from various types of materials. However, the present general inventive concept is not limited thereto.

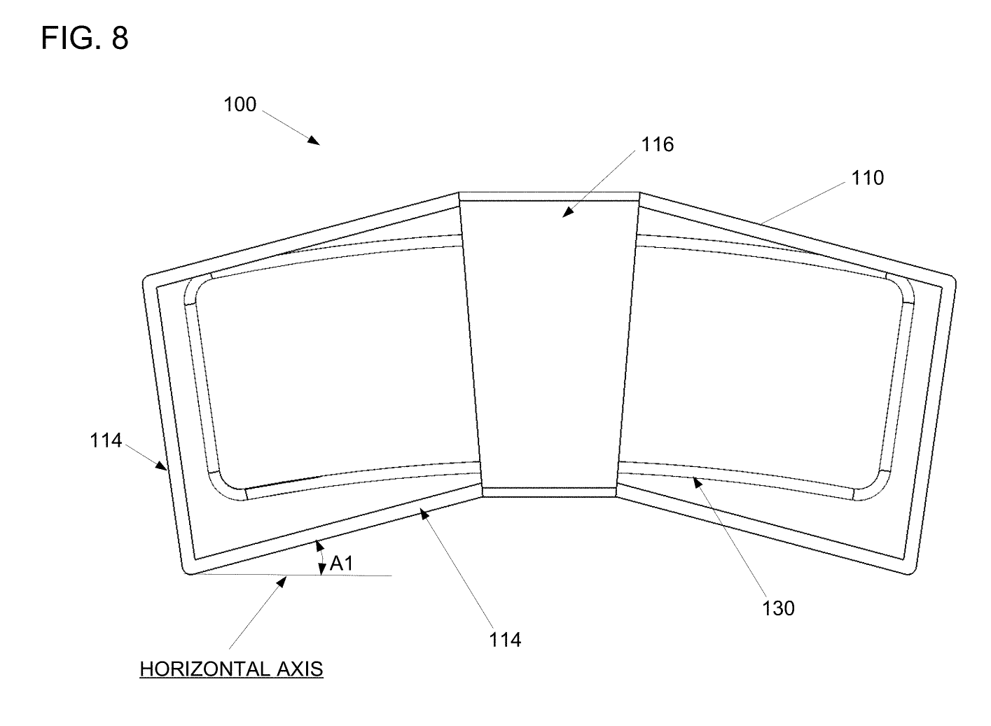

In exemplary embodiments, the plurality of sidewalls 114 may be formed of various materials including thin gauge alloys in various shapes, sizes, and thicknesses, as desired. In an exemplary embodiment, the sidewalls 114 may be formed so as to correspond to a size and shape of a conventional firearm magazine. In an exemplary embodiment, the plurality of sidewalls 114 may be formed at an angle A1 between about 5 degrees to about 30 degrees with respect to a horizontal axis. (See FIG. 8) However, the present general inventive concept is not limited thereto. That is, in alternative exemplary embodiments, the plurality of sidewalls 114 may be formed at an angle with respect to an adjacent sidewall 114 which corresponds or matches an angle formed between adjacent walls of a conventional firearm magazine 10.

The storage member 110 further includes a first end 110a and an opposing second end 110b. In the present embodiment, the storage cavity 112 is disposed between the first and second ends 110a, 110b of the storage member 110 and is designed to accommodate, house, and safely store a plurality of conventional firearm magazines 10. As such, the size and shape of the storage member 110 may be designed and/or configured to accommodate various shapes of firearm magazines 10, as needed. In the present embodiment, the first end 110a of the storage member 110 includes an opening 110c through which a firearm magazine 10 that is stored within the storage member 110 may be inserted and removed. The opening 110c of the firearm magazine dispenser apparatus 100 is designed such that the firearm magazine 10 stored within the storage cavity 112 may be removed or installed from an external environment from at least two opposing ends (i.e., a first end 110d and a second end 110e).

The storage member 110 further includes a lip 110f formed around a perimeter of the storage cavity 112 which is designed to support a weight of the follower member 120, the spring member 130, a floor plate 140, and firearm magazines 10 stored within the storage member 110.

In the present embodiment, the follower member 120 may be formed to correspond to a shape of the storage cavity 112 of the storage member 110. The follower member 120 includes a first side 120a which is used to contact a surface of a firearm magazine 10 and an opposing second side 120b which is detachably coupled to a first end 130a of the spring member 130.

Referring to FIG. 5, in the present embodiment, the second side 120b of the follower member 120 includes a cut-out portion 120c which is designed to receive at least a portion of the first end 130a of the spring member 130. As such, the follower member 120 may be detachably coupled to the spring member 130. However, the present general inventive concept is not limited thereto. That is, in alternative embodiments, the cut-out portion 120c may be sized and shaped so as to receive a wide variety of other springs.

The follower member 120 is movably disposed within the storage cavity 112 of the storage member 110 in order to push a firearm magazine 10 from the second end 110b of the storage member 110 toward the first end 110a, when the firearm magazine 10 is dispensed. The floor plate 140 includes a first side 140a that supports the second end 130b of the spring member 130 and a second side 140b that is placed against the lip 110f of the storage member 110.

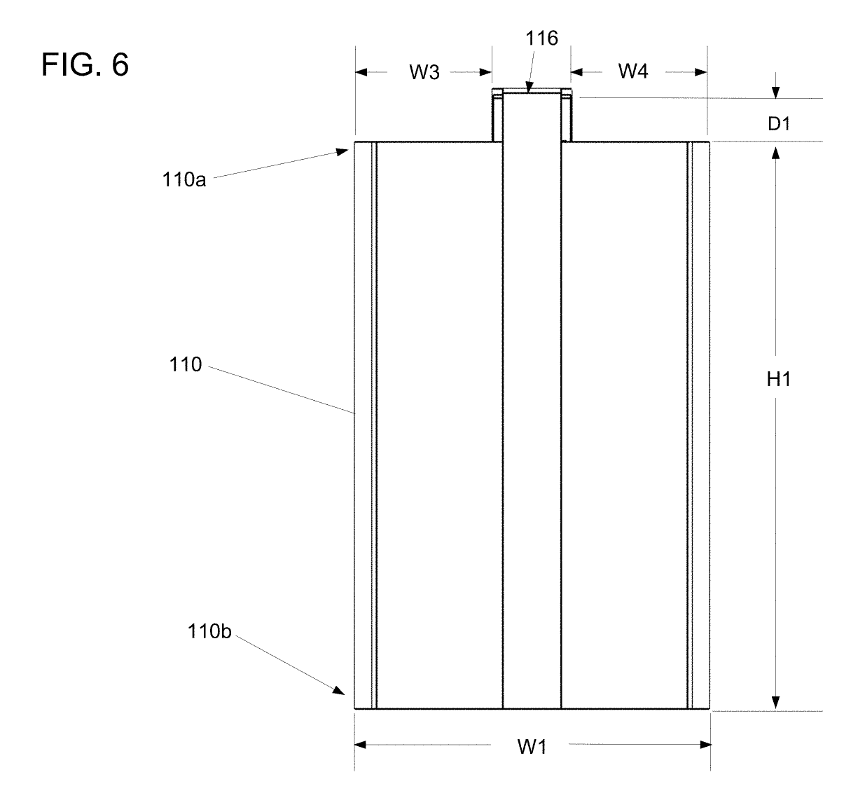

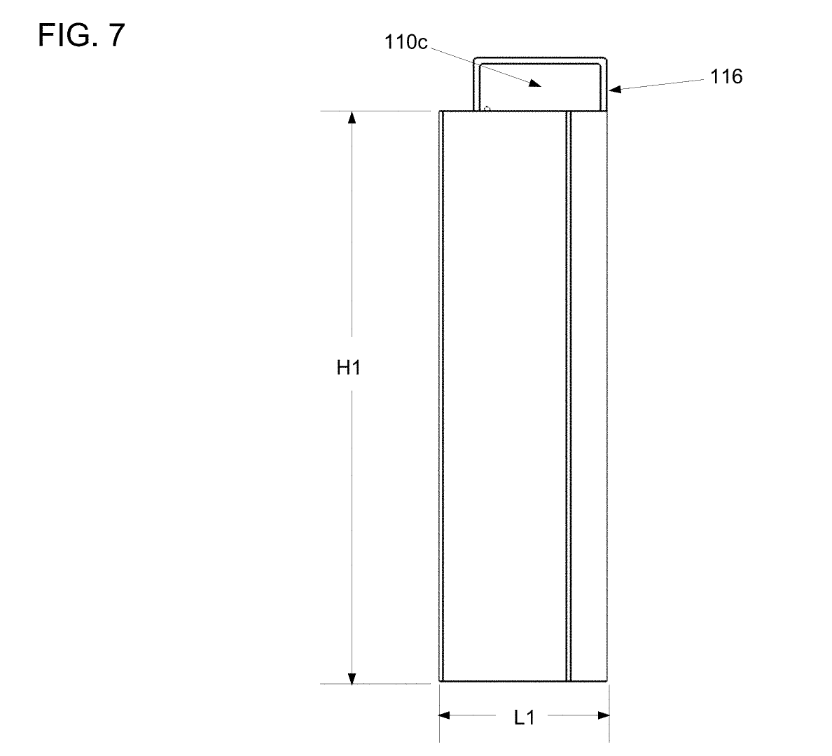

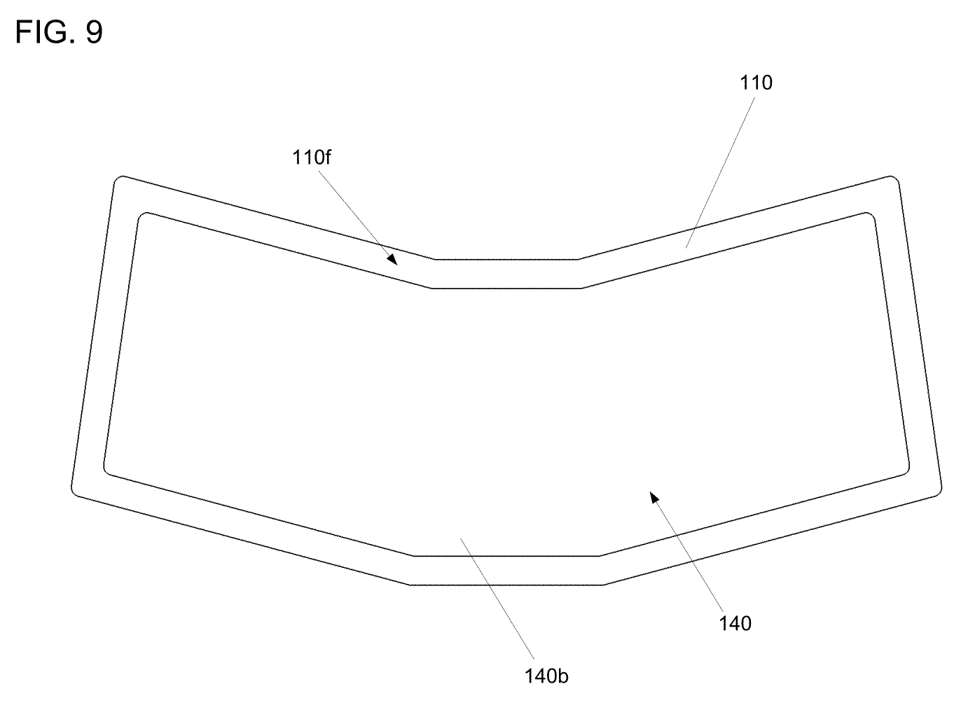

FIG. 6 is a front view of the storage member 110 illustrated in FIG. 3, FIG. 7 is a side view of the storage member 110 illustrated in FIG. 3, and FIG. 8 is a top view of the firearm magazine dispenser apparatus 100 illustrated in FIG. 3, wherein the follower member 120 is removed. FIG. 9 is a bottom view of the storage member 110 illustrated in FIG. 3.

Referring to FIG. 6, the storage member 110 further includes a firearm magazine retention member 116 which extends from the first end 110a of the storage member 110 and is used to secure a topmost firearm magazine 10 stored within the storage member 110 and may also be used as a handle for transporting the firearm magazine dispenser apparatus 100. The retention member 116 extends a distance D1 from the first end 110a of the storage member 110 to allow a firearm magazine 10 to be removed or dispensed from the firearm magazine dispenser apparatus 100. In an exemplary embodiment, the distance D1 may be about a width of a single firearm magazine 10. However, the present general inventive concept is not limited thereto.

Referring to FIGS. 6 and 7, the storage member 110 may further have a width W1 and height H1 which correspond to a width of a desired firearm magazine 10, a width of a follower member 120, a width of a spring member 130 and an amount of firearm magazines 10 desired to be stored within the storage member 110. Similarly, the storage member 110 may have length L1 which corresponds to a length of a desired firearm magazine 10. For instance, when a firearm magazine dispenser apparatus 100 is needed to store, transport, and dispense five conventional firearm magazines 10, each having a width W2 of 10 inches, a length L2 of 4 inches, and a height H2 of 2 inches, the firearm magazine dispenser apparatus 100 may be constructed with a width W1 of about 10 inches, a length L1 of about 4 inches, and a height H1 of about 10 inches. However, the present general inventive concept is not limited thereto. That is, in alternative exemplary embodiments, the dimensions H1, W1, L1, and distance D1 between the retention member 116 and the first end 110a of the storage member 110 may vary as desired to accommodate various firearm magazines 10.

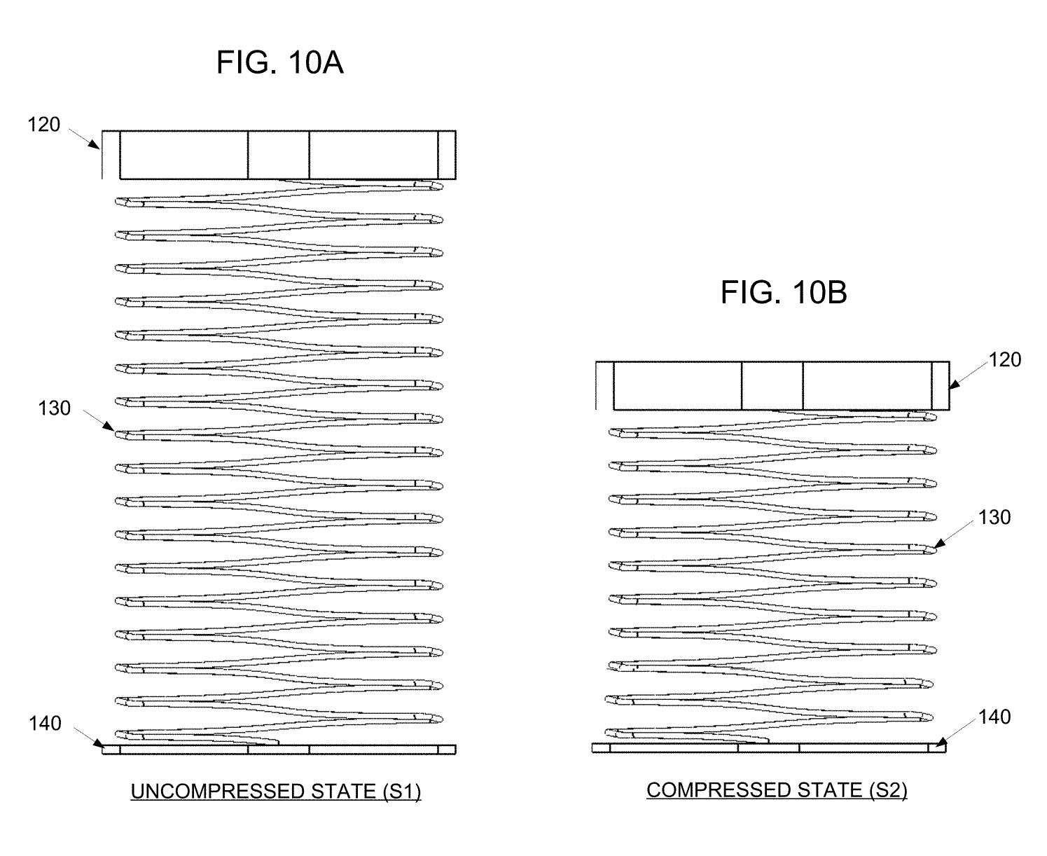

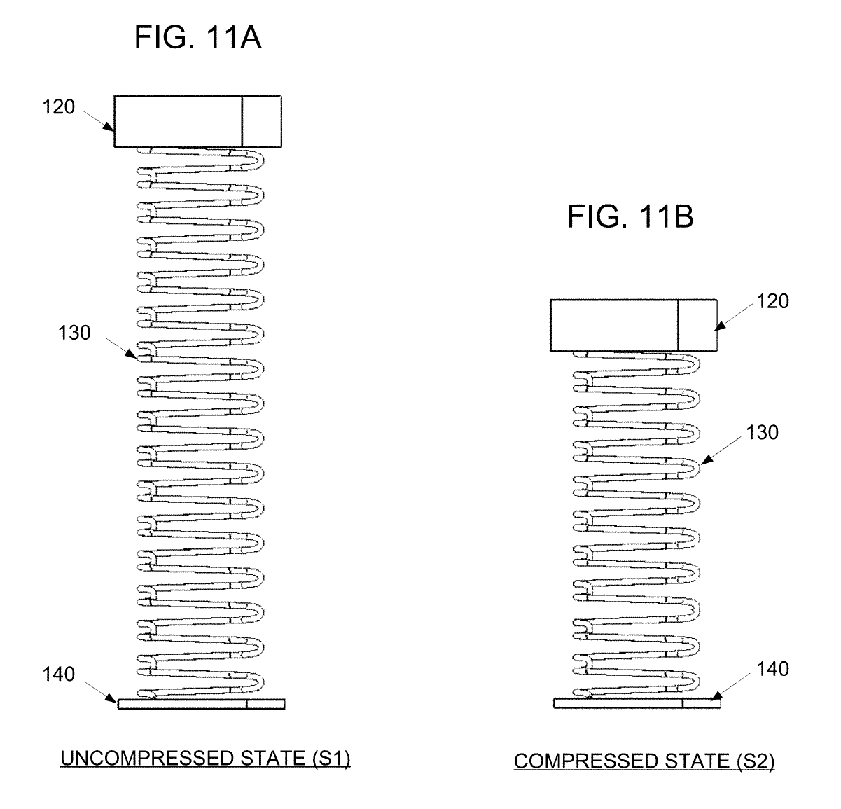

FIGS. 10A and 10B are front partial assembly views of the firearm magazine dispenser apparatus 100 illustrated in FIG. 3, wherein the storage member 110 is removed. FIGS. 11A and 11B are side partial assembly views of the firearm magazine dispenser apparatus 100 illustrated in FIG. 3, wherein the storage member 110 is removed. In particular, FIGS. 10A and 11A illustrate the follower member 120 and the spring member 130 in an uncompressed state S1 and FIGS. 10B and 11B illustrate the follower member 120 and the spring member 120 in a compressed state S2 when the storage member 110 is loaded with firearm magazines 10.

In the present embodiment, the spring member 130 is configured and designed to fit within the storage cavity 112 of the storage member 110 and to apply a force onto the follower member 120 sufficient to move a plurality of firearm magazines 10 (loaded or unloaded) from the second end 110b of the storage member 110 toward the first end 110a. As such, the spring member 130 pushes the follower member 120 toward the first end 110a of the storage member 110 to provide a user with access to a topmost firearm magazine 10 of the plurality of firearm magazines 10 stored within the storage cavity 112 of the storage member 110.

The firearm magazine dispenser apparatus 100 includes a storage member 110 that is constructed from an alloy or any other suitable material that is used to store a plurality of firearm magazines 10 (loaded or unloaded) in a single stack, a follower member 120 which is disposed within the storage member 110 and used to push against a surface of a firearm magazine 10, and a spring member 130 that is disposed within the storage member and used to apply a force onto the follower member to bias and/or push the firearm magazine 10 stored with the storage member 110 toward an opening 110c. The stack of loaded firearm magazines 10 stored within the storage member 110 is spring-loaded or pressure fed using the spring member 130. The spring member 130 applies a force onto the follower member 120, which in turn, pushes the stack of magazines toward the opening 110c of the storage cavity 112. When a topmost firearm magazine 10 is removed, the next magazine 10 in the stack moves into the topmost position and becomes accessible to the user.

Referring to FIGS. 6-8, in the present exemplary embodiment, the storage member 110 further includes a retention member 116 integrally formed with the first end 110a of the storage member 110 to releasably secure each firearm magazine 10 stored therein. The retention member 116 may extend a predetermined distance D1 from the first end 110a of the storage member 110 to allow a single firearm magazine 10 to be released and/or dispensed from the firearm magazine dispenser 100. The predetermined distance D1 may be greater than or equal to a thickness of a single conventional firearm magazine 10 and less than a combined thickness of two conventional firearm magazines 10.

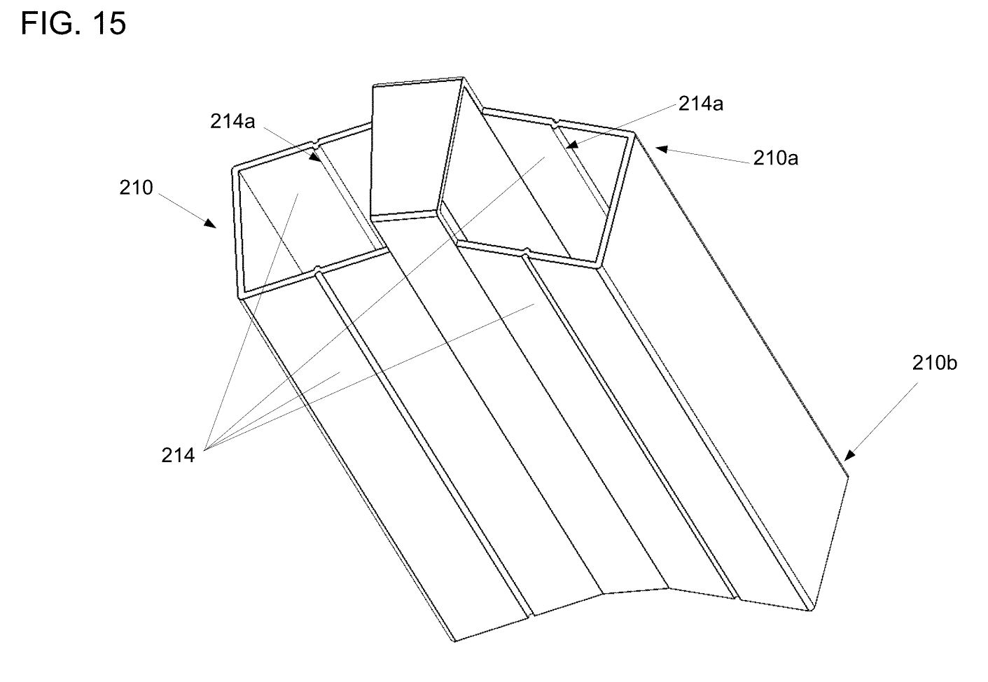

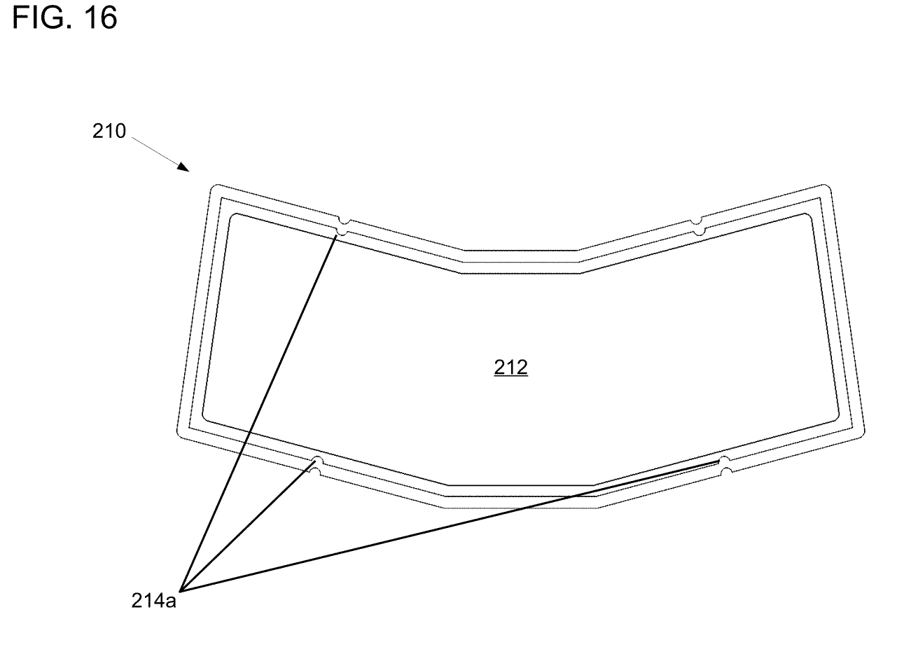

FIG. 15 is a top perspective view of a storage member 210 according to another exemplary embodiment of the present general inventive concept and FIG. 16 is a cross-sectional view of the storage member 210 illustrated in FIG. 15.

In alternative embodiments, at least one sidewall 214 may be formed with one or more rounded protrusions or rolled beads 214a which extends into the storage cavity 212 in order to provide a rounded surface which contacts a surface of the follower member 120 and/or the firearm magazine 10 to reduce an amount of friction when the firearm magazine 10 is pushed from the second end 210b toward the first end 210a by the spring member 130 and the follower member 120. In an alternative embodiment, at least one sidewall 214 is formed with one or more protrusions having various sizes and shapes extending into the storage cavity 212 which are designed to reduce friction when in contact with the follower member 120 and/or the firearm magazine 10. However, the present general inventive concept is not limited thereto.

The firearm magazine dispenser apparatus includes a storage member that is constructed from an alloy or any other suitable material that is used to store a plurality of firearm magazines (loaded or unloaded) in a single stack; a follower member which is disposed within the storage member and used to push against a surface of a firearm magazine, and a spring member that is disposed within the storage member and used to apply a force onto the follower member to bias and/or push the firearm magazine stored with the storage member toward an opening. The stack of loaded firearm magazines stored within the storage member is spring-loaded or pressure fed using the spring member. The spring member applies a force onto the follower member, which in turn, pushes the stack of magazines toward the opening of the storage cavity. When a topmost firearm magazine is removed, the next magazine in the stack moves into the topmost position and becomes accessible.

The firearm magazine dispenser apparatus according to the present general inventive concept may be easily assembled and disassembled for maintenance, without the need of any tools. That is, in the present exemplary embodiment, the follower member is first inserted into the storage cavity of the storage member through the opening, wherein the first side of the follower member is facing away from the second end 110b of the storage member. Next, the spring member is inserted into the second end 110b of the storage member. Finally, the floor plate is inserted into the second end 110b of the storage member.

The firearm magazine dispenser apparatus according to the present general inventive concept may be used in a plurality of environments, conditions, and situations. The firearm magazine dispenser apparatus may be used for a wide range of firearm magazines, including but not limited to Armalite Rife (AR) magazines. This apparatus may be deployed for use in various combat, training, or civilian applications. In alternative embodiments, the apparatus may be designed to include various tabs or attachment devices, as required.

The present general inventive concept provides a convenient, low-cost, and portable firearm magazine dispenser that can be used to safely transport, store, and dispense firearm magazines, while allowing a user to have complete access to the magazines, at all times.

The present general inventive concept provides a portable firearm magazine dispenser, which stores loaded firearm magazines in a readily accessible and usable state.

The present general inventive concept also provides a magazine storage system that can safely store and transport loaded firearm magazines in such a manner where a user can easily retrieve a loaded magazine when needed, without needing to unstrap, untie, or perform any additional step to allow access to the firearm magazines stored within the firearm magazine dispenser.

The present general inventive concept also provides a firearm magazine storage system that provides users with immediate access to extra loaded firearm magazines during time-critical situations. The firearm magazine storage system according to the present general inventive concept may be safely and securely transported with or without the use of tie downs, which, when used, do not need to be removed in order to access the stored firearm magazines. The firearm magazine storage system according to the present invention is specifically configured and/or designed to reduce the amount of time required to access and resupply personnel load-outs or reload ones firearm during combat, training exercises, or other time-critical situations. Load-outs refer to additional firearm magazines that are carried by users.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

1. A combined magazine storage, transport, and dispenser apparatus comprising:
a storage member having a storage cavity disposed between a first end and an opposing second end, the storage cavity configured to store a plurality of firearm magazines, the first end being a top end having an opening;
a follower member having a first side and an opposing second side movably disposed within the storage cavity between the first and second ends of the storage member;
a retention member integrally formed with the first end of the storage member; and
a spring member disposed within the storage cavity between the second side of the follower and the second end of the storage member,
wherein the spring member pushes the follower member toward the first end of the storage member to provide access to the plurality of firearm magazines stored therein through the opening from at least two sides of the retention member.

2. (canceled)

3. The apparatus of claim 1 wherein the storage member further includes sidewalls formed in a shape corresponding to a shape of a firearm magazine.

4. The apparatus of claim 1 wherein at least one sidewall is formed at an angle of between about 5 degrees to about 30 degrees with respect to an adjacent sidewall.

5. The apparatus of claim 1, wherein at least one sidewall is formed with one or more rounded protrusions extending into the storage cavity to reduce friction with at least one of the follower member and the firearm magazine.

6. The apparatus of claim 1, wherein storage member includes one or more openings at opposing ends to insert and remove the plurality of firearm magazines from the storage cavity.

7. The apparatus of claim 6, wherein a combined width of the one or more s openings openings is greater than half of a width of the storage member.
openings is greater than half of a width of the storage member.
